(19) United States
(12) Patent Application Publication
(10) Pub. No.: US 2026/0252542 A1
(43) Pub. Date: Aug. 27, 2026

(54) METHOD FOR SUPPORTING DISK-BASED APPROXIMATE NEAREST NEIGHBOR RETRIEVAL IN VECTOR DATABASE AND STORAGE APPARATUS FOR THEREOF

(71) Applicant: D.notitia.Inc., Seongnam-si (KR)

(72) Inventors: Dong Gyu PARK, Seoul (KR); Hong Chan ROH, Seoul (KR); Dae Gon YANG, Seoul (KR); Byong John HAN, Seoul (KR); Keun Woo LIM, Seoul (KR); Jong Hyuk IM, Seoul (KR)

(73) Assignee: D.notitia.Inc., Seongnam-si (KR)

(21) Appl. No.: 19/531,780

(22) Filed: Feb. 6, 2026

(30) Foreign Application Priority Data
Feb. 6, 2025 (KR) 10-2025-0015440

(51) Int. Cl. G06F 16/22; G06F 16/2458; G06F 16/901

(52) U.S. Cl. CPC G06F 16/2237; G06F 16/2458; G06F 16/9024

(57) ABSTRACT

Provided is a system for processing vector data including a computing node that receives a query and delivers the query and a request for returning a nearest vector for the query to a storage node, and the storage node including a disk that stores original vector data, a memory that stores lightweight vector data, and a vector processing unit that processes a similarity operation between vectors. The computing node and the storage node are connected to each other via Ethernet. According to an embodiment, it is possible to resolve performance bottlenecks by reducing data movement and processing vector operations near storage.

### CROSS-REFERENCE TO RELATED APPLICATIONS

This application claims priority under 35 U.S.C. § 119 to Korean Patent Application No. 10-2025-0015440 filed on Feb. 6, 2025, in the Korean Intellectual Property Office, the disclosures of which are incorporated by reference herein in their entireties.

### BACKGROUND

Embodiments of the present disclosure described herein relate to a hardware architecture that supports disk-based nearest neighbor retrieval in a vector database (DB) to efficiently utilize hardware resources and to satisfy search performance.

A vector database (hereinafter, referred to as a “vector DB”) refers to a database obtained by representing and storing data objects as high-dimensional vectors. Specifically, the vector DB measures the similarity between vectors to support similarity-based search. Complex data such as images, text, and audio may be mapped into a high-dimensional vector space by using the vector DB so as to be represented. The high-dimensional vectors are typically generated through machine learning or deep learning models and have the characteristic of placing semantically similar data items close together.

A vector similarity search refers to a process of finding a vector similar to a given query vector in the vector DB. Cosine similarity, Euclidean distance, and dot product may be used as a method for measuring similarity between vectors. Through this similarity measurement method, vectors closest to the query vector may be efficiently found, and the results may be returned.

The vector similarity search is utilized in a variety of applications, such as an image search, a document search, a recommendation system, and Natural Language Processing (NLP). However, as a vector dimension increases, the computational complexity increases and memory and processing power are required. Accordingly, techniques capable of improving search efficiency while the precision of the vector search is maintained may be considered.

Korean Patent Publication No. 2023-0077251 (Publication date: June 1, 2023) as a related document.

### SUMMARY

Embodiments of the present disclosure provide a hardware architecture that supports disk-based nearest neighbor retrieval in a vector database (DB) to efficiently utilize hardware resources and to satisfy search performance.

Problems to be solved by the present disclosure are not limited to the above-described problem, and other problems not mentioned herein may be clearly understood from this specification and the accompanying drawings by those skilled in the art to which the present disclosure pertains.

According to an embodiment, a system for processing vector data includes a computing node that receives a query and delivers a request for returning the query and a nearest vector for the query to a storage node, and the storage node including a disk that stores original vector data, a memory that stores light-weighted vector data, and a vector processing unit that processes a similarity operation between vectors. The computing node and the storage node are connected to each other via Ethernet.

Furthermore, the vector processing unit may search for a near candidate for the query based on data stored in the memory, and perform a similarity operation between the query and original vector data of the near candidate, and the original vector data for the near candidate may be loaded from the disk into the memory.

Moreover, the memory, the disk, and the vector processing unit may be connected to one another via a Peripheral Component Interconnect Express (PCIe) bus.

Besides, the memory may store information about a centroid vector of a cluster partitioning a vector space, or a graph-based index including a node representing a feature value of a data point, and an edge representing a relationship between a plurality of nodes.

According to an embodiment, a method for processing vector data in a vector DB system includes storing, by a storage node, original vector data in a disk and storing light-weighted vector data in a memory, receiving, by a computing node, a query and delivering the query and a request for returning a nearest vector for the query to the storage node via Ethernet, searching, by the storage node, for a near candidate for the query based on data stored in the memory, loading, by the storage node, original vector data for the near candidate from the disk into the memory, and performing, by the storage node, a similarity operation between the query and the original vector data of the near candidate.

Moreover, the loading of the original vector data for the near candidate from the disk to the memory may include loading, by the storage node, the original vector data for the near candidate from the disk to the memory via a PCI bus without disk I/O over Ethernet.

Besides, the performing of the similarity operation may include performing, by the storage node, parallel processing on the original vector data of the near candidate, which includes a plurality of near candidates, and the query.

According to an embodiment, a non-transitory computer-readable recording medium has, recorded thereon, a computer program, which is executed by a hardware computer and which is used to execute a method for processing vector data including storing, by a storage node, original vector data in a disk and storing light-weighted vector data in a memory, receiving, by a computing node, a query and delivering the query and a request for returning a nearest vector for the query to the storage node via Ethernet, searching, by the storage node, for a near candidate for the query based on data stored in the memory, loading, by the storage node, original vector data for the near candidate from the disk into the memory, and performing, by the storage node, a similarity operation between the query and the original vector data of the near candidate.

Solutions to the problem of the present disclosure are not limited to the above-described solution, and solutions not mentioned herein may be clearly understood from this specification and the accompanying drawings by those skilled in the art to which the present disclosure pertains.

### BRIEF DESCRIPTION OF THE FIGURES

The above and other aspects of the present disclosure will become apparent to those of ordinary skill in the art by describing exemplary embodiments thereof in detail with reference to the accompanying drawings.

FIG. 1 is a flowchart illustrating a process for storing vector data in a vector DB system, according to an embodiment of the present disclosure.

FIG. 2 is a flowchart for describing a process of searching for the nearest neighbor for a query in a vector DB system, according to an embodiment of the present disclosure.

FIG. 3 is a block diagram for describing a first architecture, in which a computing node and disk storage are configured separately in a vector DB system, according to an embodiment of the present disclosure.

FIG. 4 is a flowchart illustrating a query search process of a computing node and a storage node in the first architecture of FIG. 3.

FIG. 5 is a block diagram for describing a second architecture in which a computing node and disk storage are configured separately in a vector DB system, and a vector processing unit is included in the computing node, according to an embodiment of the present disclosure.

FIG. 6 is a flowchart illustrating a query search process of a computing node and a storage node in the second architecture of FIG. 5.

FIG. 7 is a block diagram for describing a third architecture, in which a computing node and disk storage are configured separately in a vector DB system, and a vector data multi-processing unit is included in a storage node, according to an embodiment of the present disclosure.

FIG. 8 is a flowchart illustrating a query search process of a computing node and a storage node in the third architecture of FIG. 7.

FIG. 9 is a diagram for describing a computing operating environment of a server providing a vector DB system, according to one embodiment of the present disclosure.

### DETAILED DESCRIPTION

Hereinafter, the preferred embodiments of the present disclosure are described with reference to the accompanying drawings.

The present disclosure may have various modifications and embodiments, and specific embodiments are illustrated in the drawings and described in detail in the detailed description. It should be understood, however, that there is no intent to limit the present disclosure to the particular forms disclosed, but on the contrary, the present disclosure is to cover all modifications, equivalents, and alternatives falling within the spirit and scope of the present disclosure. Similar reference numerals may be used for similar elements in describing drawings.

Although the terms “first”, “second”, “A”, “B”, etc. may be used to describe various components, the components should not be construed as being limited by the terms. Terms are only used to distinguish one component from another component. For example, without departing from the scope and spirit of the present disclosure, a first component may be referred to as a second component, and similarly, the second component may be referred to as the first component. The term ‘and/or’ includes the combination of a plurality of related items listed, or any one of the plurality of related items listed.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements.

The terminology used herein to describe a specific embodiment is not intended to limit the scope of the present disclosure. The terms of a singular form includes plural forms unless otherwise specified. In the specification, it should be understood that the terms “include” or “have”, when used herein, specify the presence of stated features, numbers, steps, operations, components, and/or parts, but do not preclude the presence or addition of one or more other features, numbers, steps, operations, components, parts, and/or groups thereof.

Unless otherwise defined, all terms (including technical and scientific terms) used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

The present disclosure relates to a device for multi-processing vector data and sorting the results, or a system thereof. In detail, the present disclosure relates to a multi-processing system for extracting vector data most similar to a query vector data among pieces of vector data stored in a database or a storage unit (e.g., a memory), or for quickly calculating the similarity between the pieces vector data.

The present disclosure may rapidly perform operations between pieces of multi-dimensional vector data, and may adaptively control memory usage with respect to the dimension of the vector data, thereby promoting efficient memory usage and task execution.

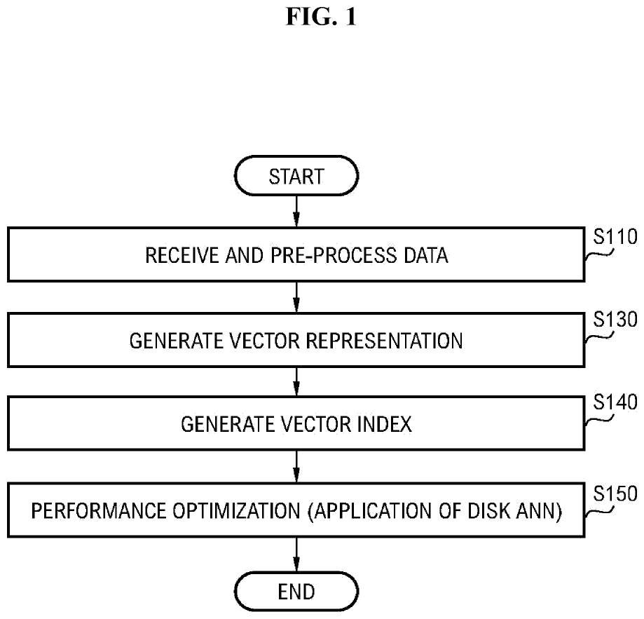

FIG. 1 is a flowchart illustrating a process for storing vector data in a vector DB system, according to an embodiment of the present disclosure.

In operation S110 of FIG. 1, the vector DB system may receive data from a client. The data may include both structured data and unstructured data. The vector DB system may assign a tenant for the user and may refine the data by performing duplication removal, normalization, and cleansing.

In operation S130 of FIG. 1, the vector DB system may generate and store a vector representation of the received data by using an embedding model. Vector embedding may be defined as representing unstructured data and/or structured data such as text, images, voice, tables, and graphs, in a multi-dimensional vector space by reflecting data characteristics. This enables the measurement of semantic similarity among data. The vector embedding may be performed in various ways, and the present disclosure should not be interpreted as limited to any specific method. For example, the vector representation may be extracted through an embedding model provided by the vector DB system. In another example, the vector representation may be extracted from an external embedding model linked to the vector DB system, not the embedding model provided by the vector DB system.

In operation S140 of FIG. 1, the vector DB system may generate and store an index for the vector representation of the data. The vector index is a data structure for quickly performing a similarity search between vectors. The vector index may be applied to a structure that clusters vector data and stores data in each cluster, a structure that hashes similar vectors to the same bucket, and a structure that hierarchically connects vectors with high similarity in a graph-based structure.

For example, the vector DB system may generate a vector index by using a graph including a node representing a feature value of a data point and an edge representing the relationship between a plurality of nodes. In the case, the graph may be formed to have a hierarchical structure. For example, a hierarchical vector index may be created by forming a plurality of layers, forming all nodes on the bottom layer, forming fewer nodes as it goes to an upper layer, and expressing relationships between layers.

For another example, the vector DB may project vector clusters based on arbitrary criteria and may create a vector index based on a projection tree that expresses relationships between vector clusters, and information about vector clusters.

Furthermore, the vector DB system may apply a vector index structure to increase the efficiency of vector search-dedicated hardware capable of multiprocessing vector data. For example, the usage efficiency of vector search-dedicated hardware may be improved by using the projection tree for searching for an upper layer of a hierarchical vector index. Specifically, a small number of vector operations are performed multiple times on the upper layers of a hierarchical vector index, thereby making parallel processing of vector operations difficult and resulting in low vector search hardware efficiency. However, until an entry point in the hierarchical vector index is found, the efficiency of parallel processing of vector operations may be improved by using the projection tree.

In the meantime, the vector DB system may perform performance optimization to efficiently search for stored vector data and vector indexes. For example, the vector DB system may include vector search-dedicated hardware to reduce Central Processing Unit (CPU) usage and to shorten a search time by processing large-scale vector operations in parallel. The vector DB system may efficiently perform distributed storage, clustering, and caching as well as parallel processing of vector data by applying a vector processing unit being vector search-dedicated hardware, thereby improving overall system efficiency. The structure of the vector search-dedicated hardware according to an embodiment of the present disclosure will be described later in the description of the attached in drawings.

Furthermore, the vector DB system according to an embodiment of the present disclosure may be optimized to secure data management efficiency and search performance by storing multidimensional large-capacity original vector data on a disk and storing the lightweight vector data in a memory.

Memory-based processing is required to provide real-time similarity search in the vector DB system. However, storing all of pieces of large-scale vector data in the memory poses a problem due to memory resource constraints. To address this issue, the vector DB system according to an embodiment of the present disclosure may have a structure that separates the memory and the disk to store the original vector data losslessly on the disk and to store a compressed lightweight vector in the memory.

For example, the vector DB system may divide a vector into sub-vectors in operation S140 and may compress each sub-vector into a codebook. Then, in operation S150, codebook information and the compressed lightweight vector may be stored in the memory, and the original vector may be maintained on the disk.

For another example, in operation S140, the vector DB system may divide the vector space into several clusters. Then, in operation S150, a centroid vector of each cluster may be maintained in the memory, and the actual vector data within the cluster may be stored on the disk.

For still another example, the vector DB system may create a graph-based index in operation S140. Then, in operation S150, the graph-based index may be stored in the memory, and the original vector data connected to graph nodes may be stored on the disk.

For yet another example, the vector DB system may convert the original vector into a binary vector by using a hashing technique in operation S140. Then, in operation S150, the binary vector may be stored in the memory, and the high-precision original vector may be stored on the disk.

In this way, the vector DB system according to an embodiment of the present disclosure may reduce memory usage and may maintain search performance, by adopting a structure in which the multidimensional large-capacity original vector data is stored on the disk and the compressed lightweight vector data is stored in the memory.

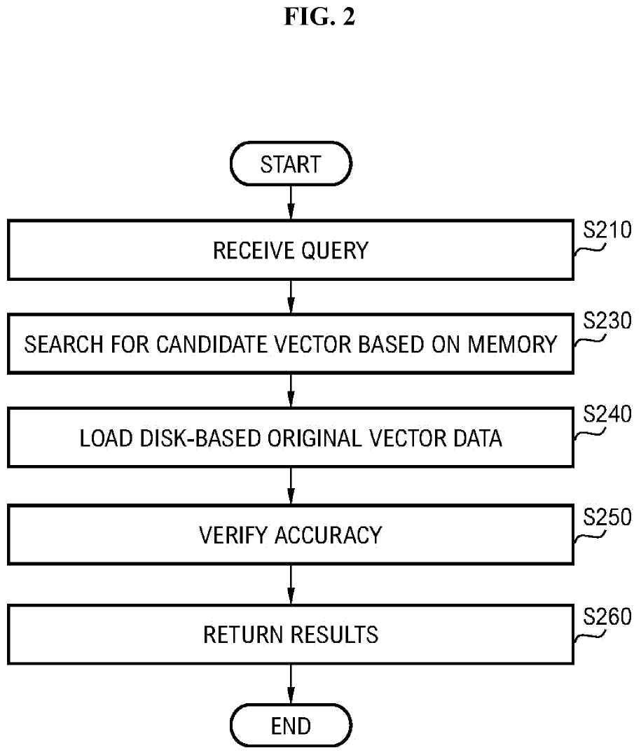

FIG. 2 is a flowchart for describing a process of searching for the nearest neighbor for a query in a vector DB system, according to an embodiment of the present disclosure.

When a query is received (S210), a vector DB system may express a query as a vector value by applying the query to a vector embedding model.

In particular, the vector DB system adopts a structure that stores original vector data on a disk and a compressed lightweight vector in a memory. Therefore, by providing a fast response time through a memory-based candidate vector search and simultaneously loading the original vector data of the candidate vector from the disk to perform accurate calculation, both search speed and performance may be secured.

In more detail, the vector DB system may search for a candidate vector based on a memory (S230). That is, the vector DB system may reduce a search scope to the memory and may search for vectors with high similarity to a query vector. For example, the vector DB system may search for near candidate vectors by using information about a centroid vector of a cluster stored in the memory, thereby minimizing disk I/O access and rapidly searching for a near candidate vector group.

Afterwards, the vector DB system may load the original vector data of a near candidate vector selected based on the memory from the disk (S240). In the case, this process incurs disk I/O, and I/O latency may be reduced by using Solid State Drive (SSD) storage.

Afterwards, the vector DB system may perform an accurate similarity calculation between original vector data read from disk and the query vector to verify accuracy (S250). The similarity calculation may use cosine similarity, Euclid distance, or inner product. In the case, the vector DB system may include a vector data multiprocessing unit to reduce CPU usage and to shorten a search time by processing large-scale vector operations in parallel.

Afterwards, the vector DB system may return the search results for the query (S260) and may then complete the process. In the case, the vector DB system may output the results to the user interface, or may perform filtering and/or sorting operations on the results.

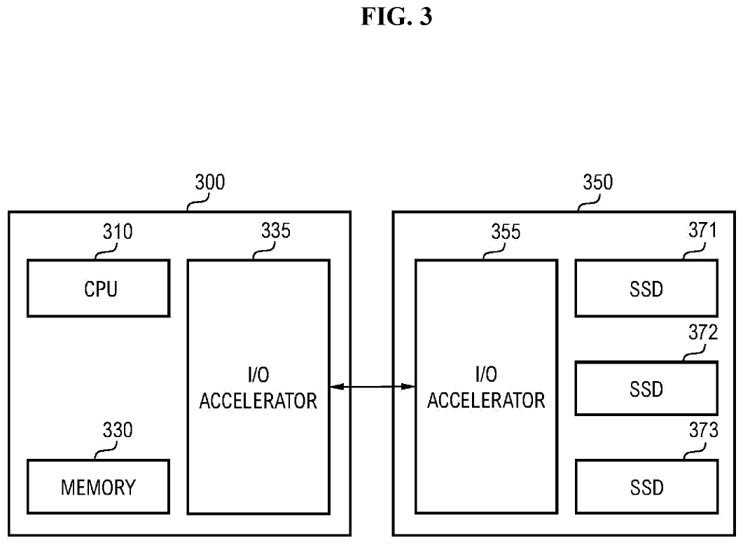

FIG. 3 is a block diagram for describing a first architecture, in which a computing node and disk storage are configured separately in a vector DB system, according to an embodiment of the present disclosure.

The first architecture of FIG. 3 includes a computing node 300 and a storage node 350. The computing node 300 includes a CPU 310, a memory 330, and an I/O accelerator 335. The storage node 350 includes an I/O accelerator 355 and a plurality of disks 371, 372, and 373.

The memory 330 and the CPU 310 processing vector operations are connected to a motherboard of the computing node 300 to communicate via a PCIe bus. However, the storage node 350 including the disks 371, 372, and 373 is configured separately from the computing node 300. In the case, the computing node 300 and the storage node 350 are connected via Ethernet via an I/O interface.

Lightweight vector data may be stored in the memory 330 of the computing node 300.

The CPU 310 of the computing node 300 processes a query and a data flow of a vector DB system and may calculate similarity between vectors.

In more detail, when the query is received, the CPU 310 may generate a search request and may quickly search for a near candidate vector in a vector index structure stored in the memory 330. Furthermore, the CPU 310 may generate a disk input/output (I/O) request to load original vector data for near candidate vectors from the disks 371, 372, and 373 of the storage node 350 into the memory 330. Besides, the CPU 310 performs a similarity calculation between the query vector and the original vector data for the near candidate vector, by using cosine similarity, Euclidean distance, or inner product.

The disks 371, 372, and 373 included in the storage node 350 store uncompressed, high-precision, and large-capacity vector data.

In the first architecture of FIG. 3, the computing node 300 and the storage node 350 are connected via Ethernet via the I/O accelerators 335 and 355. For example, the I/O accelerators 335 and 355 may be an NVMe/TCP Initiator (NTI), an NVMe/TCP Target (NTT), and/or a Data Processing Unit (DPU). The I/O accelerators 335 and 355 may improve data processing efficiency in storage and network paths.

The first architecture of FIG. 3 adopts a structure of storing the original vector data in the disks 371, 372, and 373 of the storage node 350, and storing compressed lightweight vectors in the memory 330 of the computing node 300. Therefore, by providing a fast response time through a memory-based candidate vector search and simultaneously loading the original vector data of the candidate vector from the disk to the memory 330 to perform accurate calculation, overall system performance may be enhanced.

However, in the first architecture, the CPU 310 serves both as the controller of the vector DB system and as the vector similarity calculator, which may lead to data processing bottlenecks. Furthermore, during the process of loading large-capacity vector data from the storage node 350 to the computing node 300, a significant amount of Ethernet bandwidth is occupied, thereby potentially causing a network bottleneck.

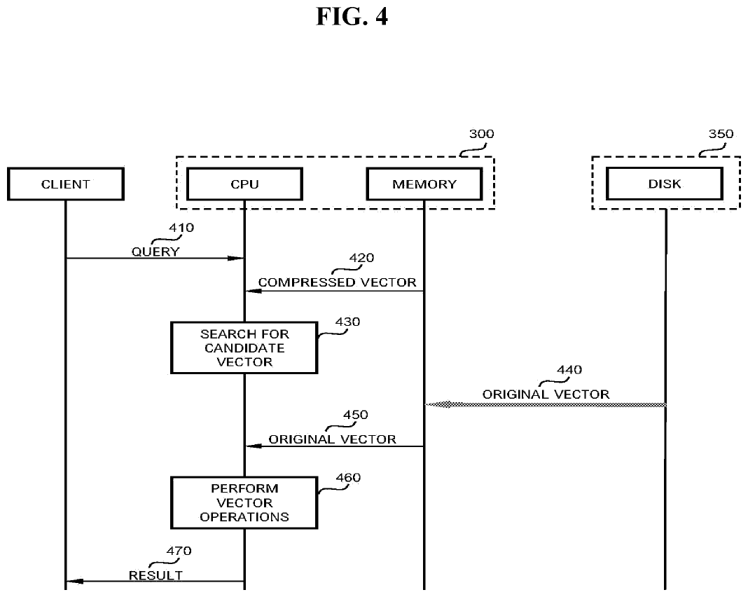

FIG. 4 is a flowchart illustrating a query search process of the computing node 300 and the storage node 350 in the first architecture of FIG. 3.

When a query of a client is received by the computing node 300 (410), the computing node 300 may apply the query to a vector embedding model to represent the query as a vector value.

The first architecture of the vector DB system adopts a structure in which the original vector data is stored on the disk of the storage node 350, and a compressed lightweight vector is stored in the memory of the computing node 300. Therefore, the CPU may identify the vector index structure stored in a memory (420) and then may quickly search for a near candidate vector (430).

Afterwards, the CPU may generate a disk I/O request to load the original vector data for the near candidate vector from the storage node 350 into the memory (440). In the case, Ethernet communication is used to load the original vector data. The large-capacity vector data occupies a significant amount of Ethernet bandwidth, and thus a network bottleneck occurs.

In the meantime, the CPU may receive the original vector data of the near candidate vector from the storage node 350 (450) and may perform vector operations between the received original vector data and the query vector (460). That is, the CPU may perform similarity calculations with the query vector by using the original vector data. In the case, the CPU serves both as the controller of the vector DB system and as the vector similarity calculator, which may lead to data processing bottlenecks.

Afterward, the CPU may return the search results for the query to the client and may complete the process (470).

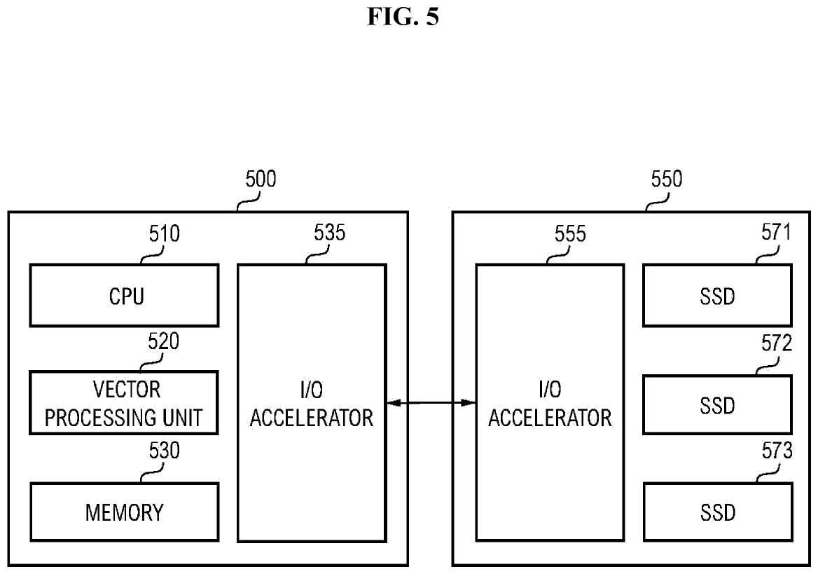

FIG. 5 is a block diagram for describing a second architecture in which a computing node and disk storage are configured separately in a vector DB system, and a vector processing unit is included in the computing node, according to an embodiment of the present disclosure.

The second architecture of FIG. 5 includes a computing node 500 and a storage node 550. The computing node 500 includes a CPU 510, a vector processing unit 520, a memory 530, and an I/O accelerator 535. The storage node 550 includes an I/O accelerator 555 and a plurality of disks 571, 572, and 573.

The second architecture of FIG. 5 differs from the first architecture of FIG. 3 in that the computing node 500 includes the vector processing unit 520, which processes vector operations in parallel. The vector processing unit 520 and the memory 530 are connected to a mainboard of the computing node 500. Moreover, the storage node 550 including the disks 571, 572, and 573 is configured separately from the computing node 500. In this case, the computing node 500 and the storage node 550 are connected via Ethernet through an I/O interface.

The vector processing unit 520 of the computing node 500 may process vector operations in parallel.

A compressed lightweight vector may be stored in the memory 530 of the computing node 500.

The CPU 510 of the computing node 500 performs the controller function of the vector DB system to process data flow and queries. The vector processing unit 520 of the computing node 500 performs similarity calculations between vectors.

Furthermore, the CPU 510 may schedule vector search tasks and may manage a workflow between the vector processing unit 520, the memory 530, and the I/O accelerator 535. In more detail, the CPU 510 may perform the function of adjusting priorities of tasks and batching vectors to increase the speed and efficiency of parallel processing of the vector processing unit 520.

In the second architecture of FIG. 5, when a query is received, the CPU 510 may generate a search request and may further generate a disk I/O request to load original vector data for a near candidate vector from the disks 571, 572, and 573 of the storage node 550 into the memory 530.

The vector processing unit 520 may quickly search for the near candidate vector within the vector index structure stored in the memory 530 and perform similarity calculations between a query vector and the original vector data for the near candidate vector. In this case, the vector processing unit 520 may rapidly process a large amount of data by performing parallel operations.

The disks 571, 572, and 573 included in the storage node 550 store uncompressed, high-precision, and large-capacity vector data.

In the second architecture of FIG. 5, the computing node 500 and the storage node 550 are connected via Ethernet via the I/O accelerators 535 and 555. For example, the I/O accelerators 535 and 555 may be Network Transfer Interfaces (NTI), Near-Storage Transfer Technology (NTT), and/or Data Processing Units (DPUs). The I/O accelerators 535 and 555 may improve data processing efficiency in storage and network paths.

The second architecture of FIG. 5 adopts a structure of storing the original vector data in the disks 571, 572, and 573 of the storage node 550, and storing compressed lightweight vectors in the memory 530 of the computing node 500. Therefore, by providing a fast response time through a memory-based candidate vector search and simultaneously loading the original vector data of the candidate vector from the disk to the memory 530 to perform accurate calculation, overall system performance may be enhanced.

Furthermore, the second architecture of FIG. 5 may include the vector processing unit 520 that performs parallel processing on vector operations in the computing node 500, may perform scheduling and general operations of vector search tasks through the CPU 510 and may perform parallel processing on large-scale vector operations through the vector processing unit 520, thereby solving the bottleneck in data processing.

However, in the second architecture of FIG. 5, during the process of loading large-capacity vector data from the storage node 550 to the computing node 500, a significant amount of Ethernet bandwidth is occupied, thereby potentially causing a network bottleneck.

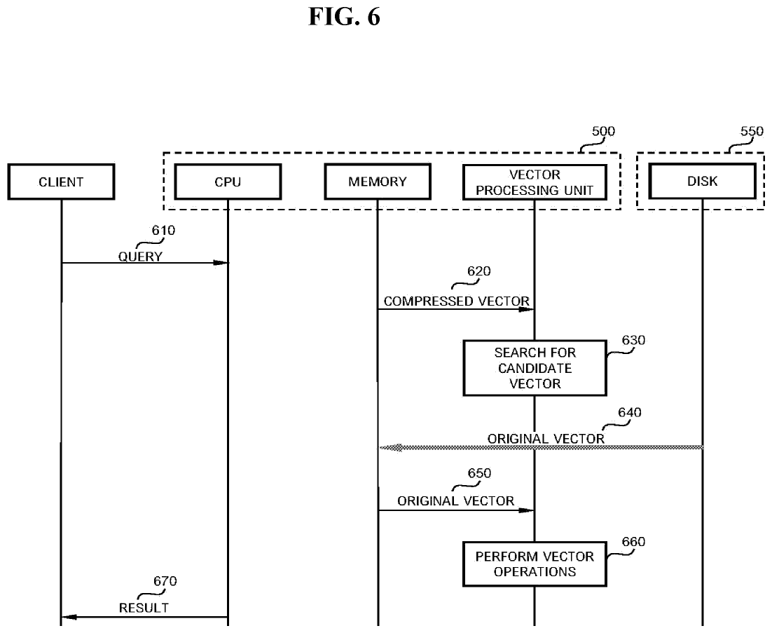

FIG. 6 is a flowchart illustrating a query search process of the computing node 500 and the storage node 350 in the second architecture of FIG. 5.

When a query of a client is received by the computing node 500 (610), the computing node 500 may apply the query to a vector embedding model to represent the query as a vector value.

The second architecture of the vector DB system adopts a structure, where original vector data is stored on the disk of the storage node 550, a compressed lightweight vector is stored in the memory of the computing node 500, and the vector processing unit processing vector operations in parallel, is located on the computing node 500. Therefore, the vector processing unit may identify the vector index structure stored in a memory (620) and then may quickly search for a near candidate vector (630).

Afterwards, the CPU may generate a disk I/O request to load the original vector data for the near candidate vector from the storage node 550 into the memory (640). In the case, Ethernet communication is used to load the original vector data. The large volume of vector data occupies a significant amount of Ethernet bandwidth, and thus a network bottleneck occurs.

In the meantime, the second architecture of the vector DB system adopts a structure in which a vector processing unit that processes vector operations in parallel is located on the computing node 500. Therefore, the vector processing unit may receive the original vector data for the near candidate vector loaded into a memory (650) and may perform vector operations between a query vector and the original vector data of the near candidate vector (660). This may resolve the bottleneck in data processing. Afterward, the CPU may return the search results for the query to the client and may complete the process (670).

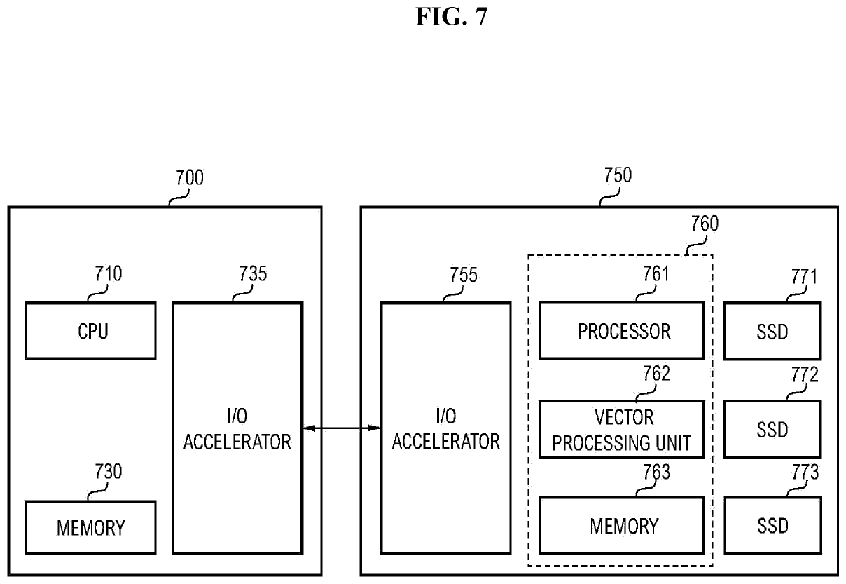

FIG. 7 is a block diagram for describing a third architecture, in which a computing node and disk storage are configured separately in a vector DB system, and a vector data multi-processing unit is included in a storage node, according to an embodiment of the present disclosure.

The third architecture of FIG. 7 includes a computing node 700 and a storage node 750. The computing node 700 includes a CPU 710, a memory 730, and an I/O accelerator 735. The storage node 750 includes an I/O accelerator 755, a vector data multi-processing unit 760, and a plurality of disks 771, 772, and 773.

The third architecture of FIG. 7 differs from the first architecture of FIG. 3 in that the vector data multi-processing unit 760 is included in the storage node 750 along with the plurality of disks 771, 772, and 773. The vector data multi-processing unit 760 and the plurality of disks 771, 772, and 773 are connected to the main board of the storage node 750 to communicate via a PCIe bus. In the meantime, the storage node 750 is configured separately from the computing node 700. In this case, the computing node 700 and the storage node 750 are connected via Ethernet through an I/O interface.

The computing node 700 serves as the controller for the vector DB system, and the CPU 710 performs the function of processing queries and returning results. In more detail, when a query is received, the CPU 710 may generate a search request and may deliver it to the storage node 750. That is, the computing node 700 may deliver a query to the storage node 750 to offload an operation. This corresponds to a vector request to return the nearest neighbors for the query, not a disk I/O request.

In the meantime, the disks 771, 772, and 773 included in the storage node 750 store uncompressed, high-precision, and large-capacity vector data.

The vector data multi-processing unit 760 of the storage node 750 may include a processor 761, a vector processing unit 762, and a memory 763.

The memory 763 stores a compressed lightweight vector.

The processor 761 may perform general operations. In detail, the processor 761 schedules vector search tasks and performs the function of managing the workflow between the vector processing unit 762, the memory 763, and the plurality of disks 771, 772, and 773.

The vector processing unit 762 may process vector operations in parallel. In particular, the vector processing unit 762 may quickly search for the near candidate vector within the vector index structure stored in the memory 763 and perform similarity calculations between a query vector and the original vector data for the near candidate vector. In this case, the vector processing unit 762 may rapidly process a large amount of data by performing parallel operations.

According to the third architecture of FIG. 7, since the vector processing unit 762, the memory 763, and the plurality of disks 771, 772, and 773 are connected to the mainboard of the storage node 750, latency between a disk (e.g., SSD storage) and an operation unit is minimized, and the movement of large amounts of vector data over Ethernet may be reduced. In particular, only query and search results are delivered over Ethernet via the I/O accelerators 735 and 755, and large amounts of vector data stored in the disks 771, 772, and 773 are not delivered over Ethernet. Accordingly, the movement of large amounts of vector data is minimized, and as a result, the occupation of Ethernet bandwidth caused by the movement of large amounts of vector data may be minimized, and network bottlenecks may be resolved.

Furthermore, the third architecture of FIG. 7 adopts a structure that stores original vector data in the plurality of disks 771, 772, and 773 of the storage node 750, and stores compressed lightweight vectors in the memory 763 adjacent to the vector processing unit 762. Therefore, by providing a fast response time through a memory-based candidate vector search and simultaneously loading the original vector data of the candidate vector from the disk to the memory 763 to perform accurate calculation, overall system performance may be enhanced.

Furthermore, the third architecture of FIG. 7 may include the vector processing unit 762 that performs parallel processing on vector operations in the storage node 750 and may perform parallel processing on large-scale vector operations through the vector processing unit 762, thereby solving the bottleneck in data processing.

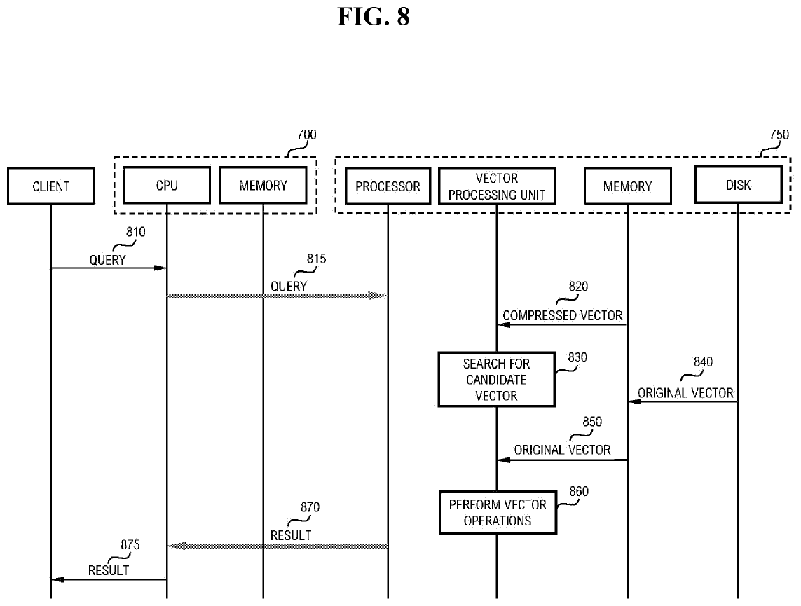

FIG. 8 is a flowchart illustrating a query search process of a computing node and a storage node in the third architecture of FIG. 7.

When a query of a client is received by the computing node 700 (810), the computing node 700 may apply the query to a vector embedding model to represent the query as a vector value.

The third architecture of the vector DB system adopts a structure in which a vector data multi-processing unit that processes vector operations in parallel is located on the storage node 750. Therefore, the computing node 700 may offload the operation by delivering the query to the storage node 750 (815).

Specifically, in operation 815, a vector request is delivered to the storage node 750, not a disk I/O request. That is, the CPU delivers a vector request to return the nearest neighbors for the query, not a request to read or write data to a disk (e.g., SSD) of the storage node.

Furthermore, the third architecture includes both a disk and a vector data multi-processing unit within the storage node 750, and adopts a structure where the disk stores original vector data, and the memory stores a compressed lightweight vector. Therefore, the vector processing unit within the vector data multi-processing unit may identify an index structure stored in the memory of the vector data multi-processing unit (820) and then may quickly search for near candidate vectors (830).

Afterwards, a processor of the vector data multi-processing unit may load the original vector data for the near candidate vector from the disk of the storage node 750 into the memory of the vector data multi-processing unit via a PCIe bus without disk I/O over Ethernet (840). In the case, since Ethernet communication is not used to load the original vector data, this prevents Ethernet bandwidth occupation and network bottlenecks caused by large-volume vector data transfers.

Afterwards, the vector processing unit may receive the original vector data for the near candidate vector loaded into a memory (850) and may perform vector operations between a query vector and the original vector data of the near candidate vector (860). This may resolve the bottleneck in data processing.

Subsequently, a processor of the storage node 750 may return the search results for the query to the computing node 700 (870), and a CPU of the computing node 700 may provide the search results for the query to a client (875).

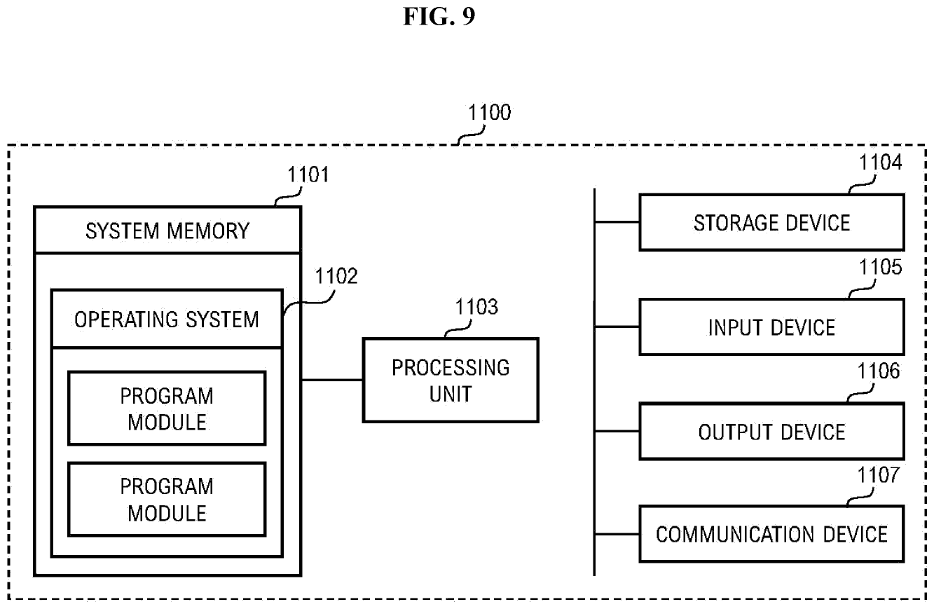

FIG. 9 is a diagram for describing a computing operating environment of a server providing a vector DB system, according to one embodiment of the present disclosure.

FIG. 9 is designed to provide a general and simplified description of a suitable computing environment in which embodiments of a system server are capable of being implemented. Referring to FIG. 9, a computing device 1100 is illustrated as an example of the system server.

The computing device 1100 may include at least one processing unit 1103 and a system memory 1101.

The computing device 1100 may include a plurality of processing units that cooperate when executing a program.

Depending on the exact configuration and type of the computing device 1100, the system memory 1101 may be a volatile memory (e.g., a RAM), a nonvolatile memory (e.g., a ROM, a flash memory, etc.), or any combination thereof. The system memory 1101 includes a suitable operating system 1102 for controlling the operation of the platform, which may be, for example, a Windows operating system from Microsoft. The system memory 1101 may include one or more software applications, such as program modules, applications, etc.

The computing device 1100 may include an additional storage device 1104 such as a magnetic disk, an optical disc, or a tape. The additional storage device 1104 may be removable storage and/or fixed storage. A computer-readable storage medium may include volatile and nonvolatile, removable and fixed media implemented in any method or technique for storage information such as computer-readable instructions, data structures, program modules, or other data.

The system memory 1101 and the storage device 1104 are merely examples of computer-readable storage media. The computer-readable storage medium may include, but is not limited to, a RAM, a ROM, an EEPROM, a flash memory or other memory devices, CD-ROM, DVD or other optical storage, a magnetic tape, magnetic disk storage or other magnetic storage devices, or any other medium that stores desired information and may be accessed by the computing device 1100.

An input device 1105 of the computing device 1100 may include, for example, a keyboard, a mouse, a pen, a voice input device, a touch input device, and a comparable input device.

An output device 1106 of the computing device 1100 may include, for example, a display, a speaker, a printer, and other types of output devices. Since the output device 1106 is widely known in the art, a detailed description is omitted.

The computing device 1100 may include a communication device 1107 that allows a device to communicate with other devices through a network in a distributed computing environment, for example, a wired/wireless network, a satellite link, a cellular link, a local area network, and a comparable mechanism. The communication device 1107 may be one example of a communication medium, and the communication medium may include computer-readable instructions, data structures, program modules, or other data. For example, the communication medium includes, but is not limited to, wired media such as wired networks or direct wired connections, and wireless media such as acoustic, RF, infrared and other wireless media.

The methods according to various embodiments of the present disclosure may be implemented in the form of program instructions which may be executed through various computer means and may be recorded in a computer-readable medium. The computer-readable medium may also include the program instructions, data files, data structures, or a combination thereof. The program instructions recorded in the medium may be designed and configured specially for the embodiments or be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like. The described hardware devices may be configured to act as one or more software modules to perform the operations of the above-described embodiments of the present disclosure, or vice versa.

While embodiments have been shown and described with reference to the accompanying drawings, it will be apparent to those skilled in the art that various modifications and variations may be made from the foregoing descriptions. For example, adequate effects may be achieved even though the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

The system according to embodiments may resolve performance bottlenecks by reducing data movement and processing vector operations near storage.

The system according to embodiments may process vector data at high speed, may improve computational speed by efficiently utilizing disk and memory resources, and may support fast similarity operations even on large datasets, thereby making it effective for real-time search systems and large-scale data analysis.

The system according to embodiments may alleviate data processing bottlenecks and may increase processing speed through vector data parallel search. Furthermore, by optimizing communication bandwidth between storage and a computational unit and minimizing latency, memory overload issues capable of occurring when high-dimensional vector data is processed may be resolved, and system stability may be ensured.

The system according to embodiments may reduce data movement through a vector data multiprocessing unit located in a storage node, may efficiently process large amounts of high-dimensional vector data, and may maximize the speed of comparison operations, thereby providing users with fast and accurate similarity calculation results.

Effects of the present disclosure are not limited to the above-described effects, and any other effects not mentioned herein may be clearly understood from this specification and the accompanying drawings by those skilled in the art to which the present disclosure pertains.

What is claimed is:

1. A system for processing vector data, the system comprising:
a computing node configured to receive a query and to deliver the query and a request for returning a nearest vector for the query to a storage node; and
the storage node including a disk configured to store original vector data, a memory configured to store lightweight vector data, and a vector processing unit configured to process a similarity operation between vectors,
wherein the computing node and the storage node are connected to each other via Ethernet.

2. The system of claim 1, wherein the vector processing unit searches for a near candidate for the query based on data stored in the memory, and performs a similarity operation between the query and original vector data of the near candidate, and
wherein the original vector data for the near candidate is loaded from the disk into the memory.

3. The system of claim 1, wherein the memory, the disk, and the vector processing unit are connected to one another via a Peripheral Component Interconnect Express (PCIe) bus.

4. The system of claim 1, wherein the memory stores a graph-based index comprising nodes that represent information about centroid vectors of clusters partitioning a vector space or feature values of data points, and edges that represent between a plurality of nodes.

5. A method for processing vector data in a vector DB system, the method comprising:
storing, by a storage node, original vector data in a disk and storing lightweight vector data in a memory;
receiving, by a computing node, a query and delivering the query and a request for returning a nearest vector for the query to the storage node via Ethernet;
searching, by the storage node, for a near candidate for the query based on data stored in the memory;
loading, by the storage node, original vector data for the near candidate from the disk into the memory; and
performing, by the storage node, a similarity operation between the query and the original vector data of the near candidate.

6. The method of claim 5, wherein the loading of the original vector data for the near candidate from the disk to the memory includes:
loading, by the storage node, the original vector data for the near candidate from the disk to the memory via a PCI bus without disk I/O over Ethernet.

7. The method of claim 5, wherein the performing of the similarity operation includes:
performing, by the storage node, parallel processing on the original vector data of the near candidate, which includes a plurality of near candidates, and the query.

8. A non-transitory computer-readable recording medium having, recorded thereon, a computer program, which is executed by a hardware computer and which is used to execute a method for processing vector data, the method comprising:
storing, by a storage node, original vector data in a disk and storing lightweight vector data in a memory;
receiving, by a computing node, a query and delivering the query and a request for returning a nearest vector for the query to the storage node via Ethernet;
searching, by the storage node, for a near candidate for the query based on data stored in the memory;
loading, by the storage node, original vector data for the near candidate from the disk into the memory; and
performing, by the storage node, a similarity operation between the query and the original vector data of the near candidate.
